(19) United States
(12) Patent Application Publication
(10) Pub. No.: US 2014/0318364 A1
(43) Pub. Date: Oct. 30, 2014

(54) RACING TRANSMISSION DIRECT PORT VALVE BODY SERVO ASSEMBLY

(71) Applicant: Carl Rossler, Girard, OH (US)

(72) Inventor: Carl Rossler, Girard, OH (US)

(21) Appl. No.: 14/255,097

(22) Filed: Apr. 17, 2014

Related U.S. Application Data
(60) Provisional application No. 61/816,347, filed on Apr. 26, 2013.

(51) Int. Cl. F15B 9/00

(52) U.S. Cl. CPC F15B 9/00
USPC 91/358 R

(57) ABSTRACT

A valve body and servo combination for a power shift racing transmission with a valve body and a valve cover integrally mounted on the transmission housing. The valve body includes flow control valves and an integral rear servo assembly reducing the complexity of fluid flow travel path thereby eliminating the original constriction ports in all factory and aftermarket transmission case applications.

This application claims the benefit of U.S. Provisional Application No. 61/816,347, filed Apr. 26, 2013.

### BACKGROUND OF THE INVENTION

1. Technical Field

This invention relates to power shift vehicle transmissions and more specifically to transmission cases and rear servo assemblies and valve body mounted thereto.

2. Description of Prior Art

Prior art racing transmissions, factory or aftermarket on a vehicle, require valving to control the hydraulic fluid pressure supplied to the transmission and modulate hydraulic fluid pressure. Flow control valves normally control the operation of the selected hydraulic actuators for clutches being engaged and disengaged and activated by a plurality of flow control valves which are required. The rear servo assembly is separate from the valve body, requiring that hydraulic fluid must flow from the valve body into the transmission case following a torturous and restricted flow path, which effectively slows down the flow of fluid to apply and also release time thereof, which by definition and orientation of the very constricted fluid flow path.

### SUMMARY OF THE INVENTION

A direct port valve body servo combination for a racing power transmission that provides for the mounting of the servo assembly on the transmission valve body in a one piece integral design. This combination eliminates the original constricted ports associated with current design and provides for direct port flow from the valve body to the rear servo assembly now integral therewith, and will increase performance and flow time therebetween.

### DESCRIPTION OF THE DRAWINGS

FIG. 1 is a top plan view of the servo combined valve body in solid and broken lines.

FIG. 2 illustrated a graphic side view of the servo combined valve body in solid and broken lines.

FIG. 3 is a composite exploded graphic illustration of prior art independent valve body and transmission case with servo mounting thereon.

### DESCRIPTION OF THE PREFERRED EMBODIMENT

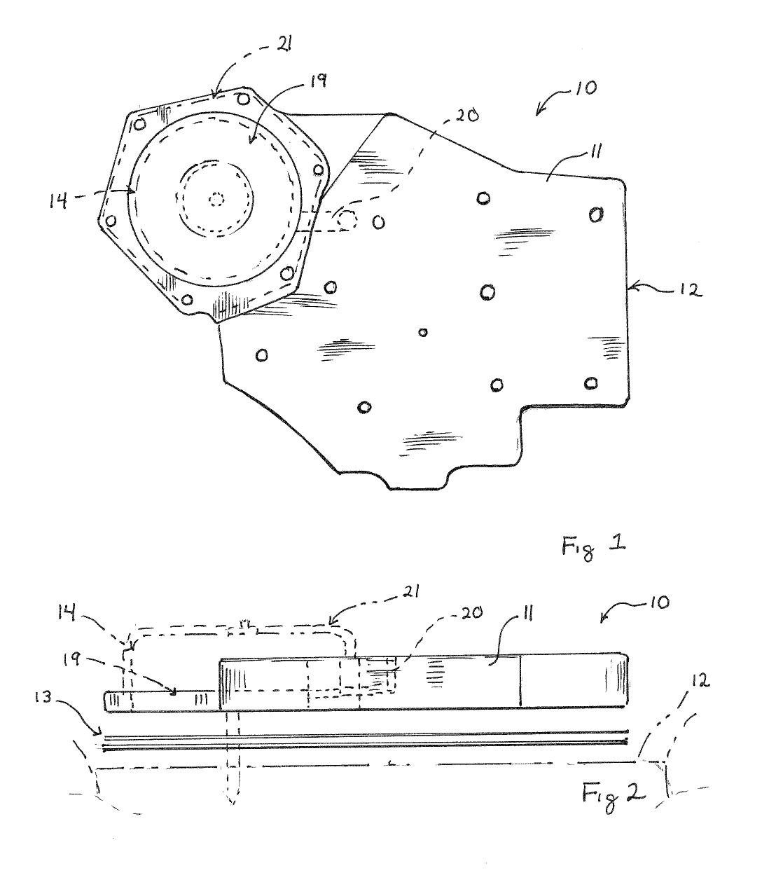

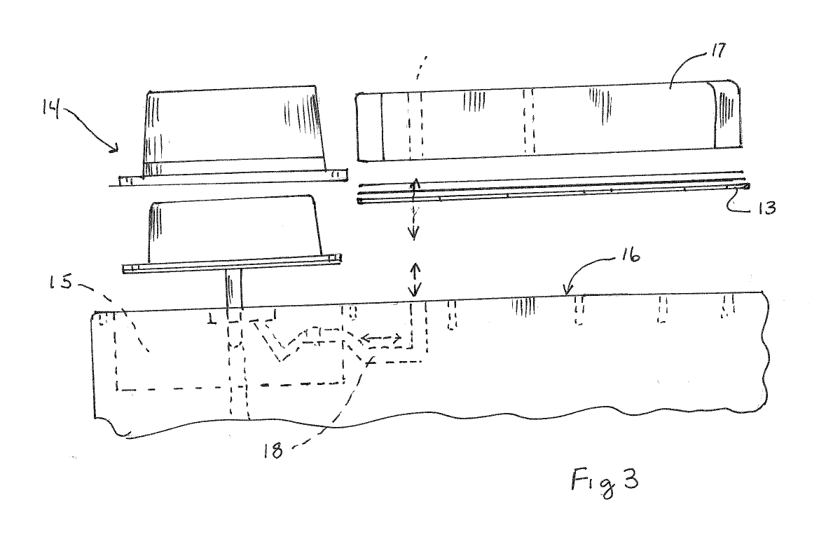

Referring to FIGS. 1 and 2 of the drawings, the valve body servo composite body member 10 of the invention can be seen having a modified transmission valve body 11 which is secured to the transmission housing 12 with a specially configured gaskets 13 therebetween, as also illustrated in prior art disclosure in FIG. 3 of the drawings. As such prior art applications have heretofore required the rear servo control assembly 14 to be mounted within a fitted recess 15 on a traditionally configured transmission valve body housing 16 so as to be independent of a corresponding control valve body 17 secured adjacent thereto over the transmission valve body housing 16.

It will therefore be evident that given the disclosed and illustrated prior art orientation, that the rear servo control assembly 14 heretofore has an indirect and torturous fluid conduit path 18 indicated by flow arrows to and from the prior art control valve body 17 as is well known and understood by those skilled in the art.

This indirect orientation of the existing designs found in this example as illustrated of a TH 400 racing transmission, will effectively slow down the hydraulic fluid flow and therefore the “release time” of the racing transmission.

The present invention provides a completely new composite transmission valve body member configuration 11 having an inclusive integrated recessed mounting 19 for the installation of the rear servo control assembly 14 as seen in FIGS. 1 and 2 of the drawings. The novel one piece valve body composite body member 11 provides by design a more direct improved conduit path 20 to port flow from the control valve body member 11 to the defined rear “low reverse” installed servo control 14 as is understood within the art.

It will be seen therefore that given the direct proximity introduced by the newly configured orientation that improved transmission performance is achieved as to decreasing the applied and release time of the rear “servo” and therefore the performance of the so-modified racing transmission to which this improvement is applied as a primary example.

Additionally, a rear servo cover 21 is provided to accommodate for variations in transmission cases, low reverse bands, and reaction carrier diameters as will be known and understood within the art.

As noted, the one piece valve body composite 10 of the invention is mounted on the transmission housing 12 for connection to suitable controls for operation by the operator (no shown) of the vehicle as per normal operational requirements.

The use of the composite transmission valve body assembly 11 provides for an integral compact arrangement for the rear servo control 14 and valves required to operate a power shift transmission. The more direct and less encumbered defined control fluid path 19 that is achieved in that of prior art as hereinbefore described, allows for faster improved release times, which by definition is of critical difference in racing venues to which the invention is addressed.

It will thus be seen that a new and novel integrated racing transmission direct path valve body servo assembly has been illustrated and described and that various changes and modifications may be made therein without the departing from the spirit of the invention.

Therefore I claim:

1. A valve assembly valve body for mounting on a transmission housing of a power shift transmission having an opening for receiving a valve body comprising,
a main valve body member having a valve body portion and integral rear servo control mounting portion,
a foreshortened fluid control passage extending between said valve body portion and said rear servo control mounting portion for reduced control fluid flow time therebetween,
a rear servo control assembly in communication with said valve body portion and said transmission.

2. The valve assembly valve body set forth in claim 1 wherein a rear servo cover for said rear servo control assembly selectively secured to said rear servo control mounting portion.

3. The valve assembly valve body set forth in claim 1 wherein said rear servo control mounting portion comprises,
an annular recess within said main valve body member, aperture fastener receiving means and select portal egress with said adjacent mounted independent valve body.
